(19) United States
(12) Patent Application Publication
(10) Pub. No.: US 2015/0286310 A1
(43) Pub. Date: Oct. 8, 2015

(54) PASSIVE TOUCH PEN

(71) Applicant: Primax Electronics Ltd., Neihu (TW)

(72) Inventors: A-MING CHANG, Neihu (TW); Chien-Pang Chien, Neihu (TW); Ying-Che Tseng, Neihu (TW)

(21) Appl. No.: 14/305,885

(22) Filed: Jun. 16, 2014

(30) Foreign Application Priority Data
Apr. 3, 2014 (CN) 201420160899.9

(51) Int. Cl. G06F 3/044; G06F 3/0354

(52) U.S. Cl. CPC G06F 3/044; G06F 3/03545

(57) ABSTRACT

A passive touch pen for a capacitive touch screen is provided. The passive touch pen includes a first pen tube, a second pen tube, a fixing post, a conductive pen tip, a circuit board, and a conductive element. The first pen tube is made of a conductive material. The second pen tube is made of a nonconductive material. The conductive element is connected with a negative trace of the circuit board and contacted with the first pen tube. Consequently, the electric energy of the human body is transmitted to the conductive pen tip through the conductive element. Moreover, a negative electrode part is electrically connected with the negative trace of the circuit board through the first pen tube and the conductive element. Consequently, the complexity of the fabricating process and the fabricating cost are reduced.

### FIELD OF THE INVENTION

The present invention relates to a touch pen, and more particularly to a passive touch pen for a capacitive touch screen.

### BACKGROUND OF THE INVENTION

Nowadays, the commercially available touch screens are classified into several types, including a resistive touch screen, an acoustic wave touch screen, an infrared touch screen and a capacitive touch screen. When an external force is exerted on the resistive touch screen, a voltage is generated and a command is recognized according to the voltage. Moreover, acoustic waves or infrared rays pass over the surface of the acoustic wave touch screen or the infrared touch screen. By touching the surface of the acoustic wave touch screen or the infrared touch screen, the travelling path of the acoustic wave or the infrared ray is blocked and thus the corresponding command is recognized. When the human body is contacted with the capacitive touch screen, the capacitance value of the touch point of the touch screen is subjected to a change. According to the change of the capacitance value, the touch position is recognized. In views of the touch accuracy and the fabricating cost, the capacitive touch screen is widely adopted.

For complying with the utilized function of the capacitive touch screen, a capacitive touch pen is introduced into the market. Generally, the capacitive touch pen is used for tapping or selecting the capacitive touch screen. In addition, the capacitive touch pen may also have the handwriting and drawing functions. In accordance with the current technology, the capacitive touch pens are classified into two types, i.e. active touch pens and passive touch pens. The passive touch pen has a contact tip made of a conductive rubber. Moreover, the conductive rubber tip is combined with a metallic pen tube. When the conductive rubber tip touches the capacitive touch screen, the electric energy of the human body is transmitted to the conductive rubber tip through the metallic pen tube. Consequently, the capacitance value of the touch point between the capacitive touch screen and the conductive rubber tip is changed.

Hereinafter, the structure of a conventional passive touch pen will be illustrated with reference to FIG. 1. FIG. 1 is a schematic exploded view illustrating a conventional passive touch pen. As shown in FIG. 1, the conventional passive touch pen 1 comprises a hollow metallic pen tube 11 and a sensing pen tip set 12. The sensing pen tip set 12 is fixed on a front end 111 of the pen tube 11. The pen tube 11 may be grasped by the user's hand. When the sensing pen tip set 12 at the front end 111 of the pen tube 11 touches the touch screen, a pointing effect (not shown) on the touch screen is correspondingly controlled.

The sensing pen tip set 12 at least comprises a conductive rubber tip 121 and a fixing post 122. The conductive rubber tip 121 may touch a surface of the touch screen (not shown). The fixing post 122 is used to fix the conductive rubber tip 121.

When the pen tube 11 is grasped by the user, the electric energy of the human body is transmitted to the conductive rubber tip 121 through the pen tube 11 and the fixing post 122. Consequently, a coupling capacitance between the conductive rubber tip 121 and the capacitive touch screen is generated. According to the coupling capacitance, a position of the touch point between the conductive rubber tip 121 and the touch screen may be calculated by a controller (not shown) of the touch screen.

However, the conventional passive touch pen 1 still has some drawbacks. For example, since the entire of the pen tube 11 is made of a metallic material, the fabricating cost of the passive touch pen 1 is high. If the entire of the pen tube 11 is made of a nonconductive material, the electric energy of the human body fails to be transmitted through the pen tube 11.

Therefore, there is a need of providing a cost-effective passive touch pen capable of transmitting the electric energy of the human body.

### SUMMARY OF THE INVENTION

An object of the present invention provides a passive touch pen. The pen tubes of the passive touch pen are made of a metallic material and a non-metallic material, so that the fabricating cost is reduced.

In accordance with an aspect of the present invention, there is provided a passive touch pen for a capacitive touch screen. The passive touch pen includes a first pen tube, a second pen tube, a fixing post, a conductive pen tip, a circuit board, and a conductive element. The first pen tube is made of a conductive material. The second pen tube is made of a nonconductive material. A rear end of the second pen tube is connected with the first pen tube. The fixing post is made of a conductive material. The fixing post is disposed within the second pen tube and located near a front end of the second pen tube. The conductive pen tip is connected with the fixing post and exposed outside the front end of the second pen tube. The circuit board is disposed within the second pen tube. The conductive element is disposed within the second pen tube and connected with a negative trace of the circuit board. A first end of the conductive element is contacted with the first pen tube. Consequently, the first pen tube, the conductive element, the fixing post and the conductive pen tip are electrically connected with each other.

In accordance with another aspect of the present invention, there is provided a passive touch pen for a capacitive touch screen. The passive touch pen includes a first pen tube, a second pen tube, an inner metal plate, a fixing post, a conductive pen tip, a circuit board, a front conductive piece, and a rear conductive piece. The first pen tube is made of a conductive material. The second pen tube is made of a nonconductive material. A rear end of the second pen tube is connected with the first pen tube. The inner metal plate is connected with the second pen tube. The fixing post is made of a conductive material. The fixing post is disposed within the second pen tube and located near a front end of the second pen tube. The conductive pen tip is connected with the fixing post and exposed outside the front end of the second pen tube. The circuit board is disposed within the second pen tube. The front conductive piece is disposed within the second pen tube, located near the conductive pen tip, and contacted with the inner metal plate. The rear conductive piece is disposed within the second pen tube, located near the rear end of the second pen tube, and connected with a negative trace of the circuit board. The rear conductive piece is connected with the first pen tube and the inner metal plate. Consequently, the first pen tube, the rear conductive piece, the inner metal plate, the front conductive piece, the fixing post and the conductive pen tip are electrically connected with each other.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a conventional passive touch pen;

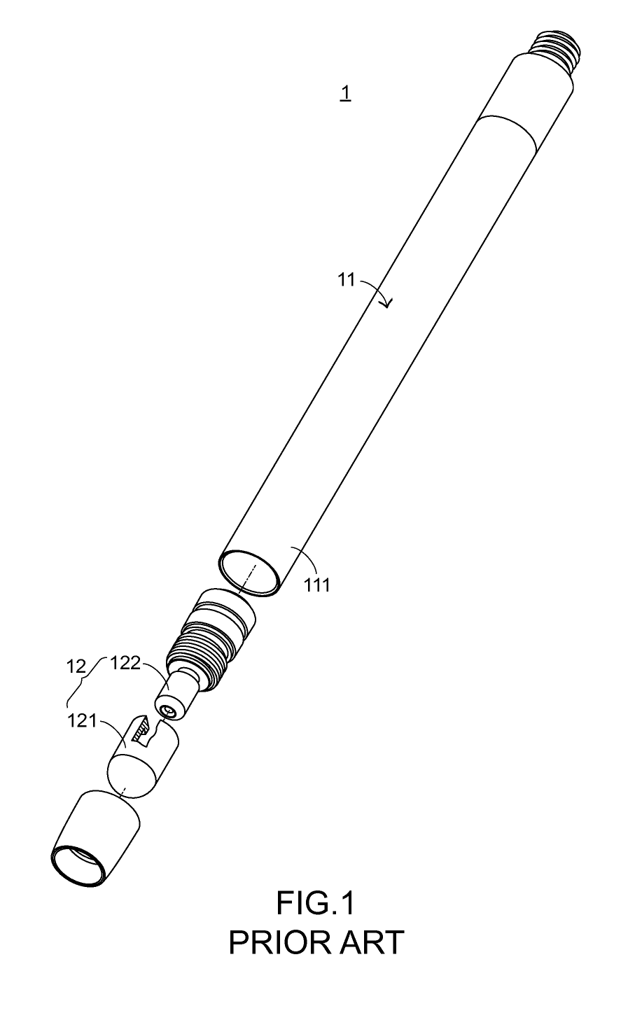

FIG. 2 is a schematic perspective view illustrating the outer appearance of a passive touch pen according to a first embodiment of the present invention;

FIG. 3 is a schematic exploded view illustrating the passive touch pen according to the first embodiment of the present invention;

FIG. 4 is a schematic exploded view illustrating a circuit board, a conductive element, a fixing post and the conductive pen tip of the passive touch pen of FIG. 3;

FIG. 5 is a schematic cross-sectional view illustrating the conductive pen tip of the passive touch pen according to the first embodiment of the present invention;

FIG. 6 is a schematic exploded view illustrating the inner structure of a second pen tube of a passive touch pen according to a second embodiment of the present invention and taken along a first viewpoint;

FIG. 7 is a schematic exploded view illustrating the inner structure of the second pen tube of the passive touch pen according to the second embodiment of the present invention and taken along a second viewpoint;

FIG. 8 is a schematic exploded view illustrating the inner structure of the first pen tube of the passive touch pen according to the second embodiment of the present invention;

FIG. 9 is a schematic cutaway view illustrating the passive touch pen according to the second embodiment of the present invention; and

FIG. 10 is a schematic perspective view illustrating the outer appearance of a passive touch pen according to a third embodiment of the present invention.

### DETAILED DESCRIPTION OF THE PREFERRED EMBODIMENT

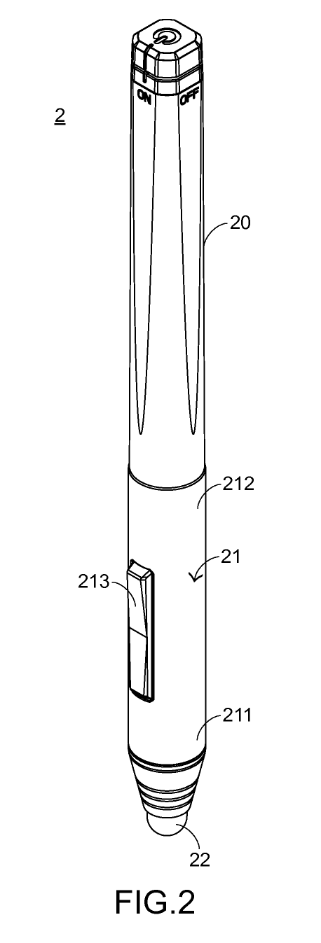

Hereinafter, a passive touch pen 2 according to a first embodiment of the present invention will be illustrated with reference to FIG. 2. FIG. 2 is a schematic perspective view illustrating the outer appearance of a passive touch pen according to a first embodiment of the present invention.

As shown in FIG. 2, the passive touch pen 2 comprises a first pen tube 20, a second pen tube 21, and a conductive pen tip 22. The conductive pen tip 22 is located at a front end 211 of the second pen tube 21. By grasping the first pen tube 20 or the second pen tube 21, the user may operate the conductive pen tip 22 to control a capacitive touch screen (not shown). The passive touch pen 2 of this embodiment at least provides a function of sensing a pen pressure. The function of sensing the pen pressure will be illustrated as follows.

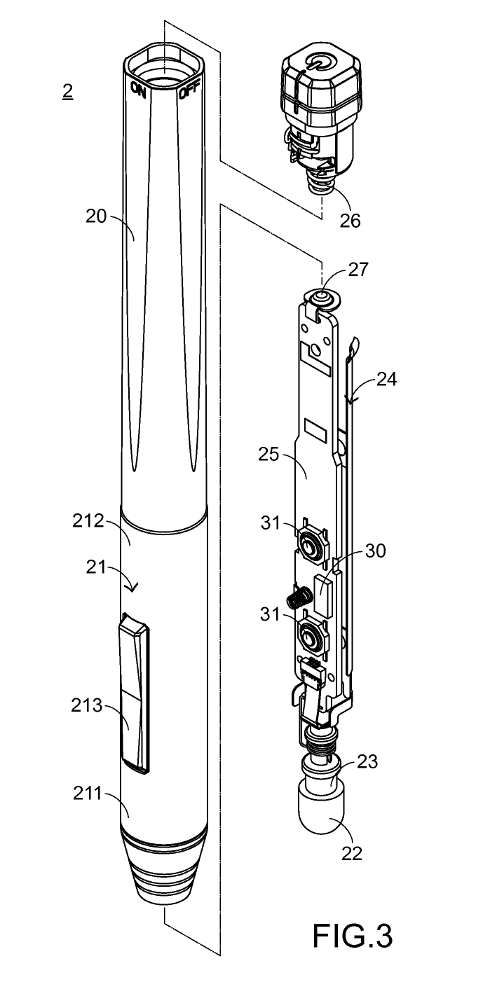

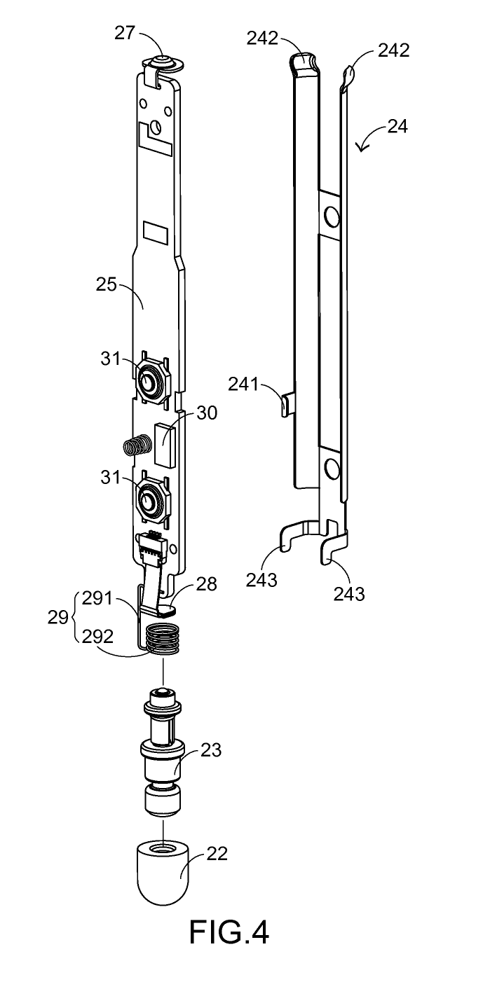

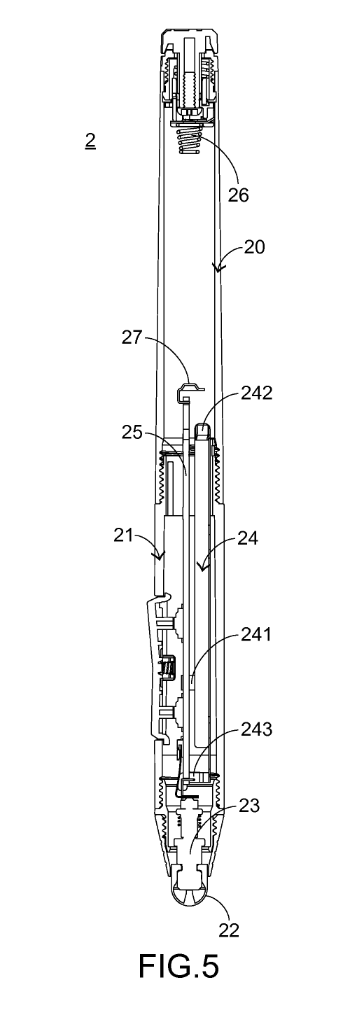

Hereinafter, the components of the passive touch pen 2 and the assembling sequence thereof will be illustrated with reference to FIGS. 3-5. FIG. 3 is a schematic exploded view illustrating the passive touch pen according to the first embodiment of the present invention. FIG. 4 is a schematic exploded view illustrating a circuit board, a conductive element, a fixing post and the conductive pen tip of the passive touch pen of FIG. 3. FIG. 5 is a schematic cross-sectional view illustrating the conductive pen tip of the passive touch pen according to the first embodiment of the present invention.

As shown in FIGS. 3 and 4, the passive touch pen 2 comprises the first pen tube 20, the second pen tube 21, the conductive pen tip 22, a fixing post 23, a conductive element 24, a circuit board 25, a negative electrode part 26, a positive electrode part 27, a pressure sensor 28, a conductive spring 29, and a wireless transmission module 30. In this embodiment, the first pen tube 20 is made of a conductive material (e.g. a metallic material), the second pen tube 21 is made of a nonconductive material (e.g. a plastic material), the conductive pen tip 22 is made of a conductive rubbery material, and the fixing post 23 is made of a metallic material or a conductive plastic material. It is noted that the materials of these components are not restricted. Moreover, the conductive element 24 is an elongated conductive plate made of a metallic material.

Please refer to FIGS. 3-5 again. For assembling the passive touch pen 2, a rear end 212 of the second pen tube 21 is connected with the first pen tube 20. The circuit board 25 is disposed within the second pen tube 21, and the pressure sensor 28 and an end 291 of the conductive spring 29 are connected with a bottom edge of the circuit board 25. Moreover, the wireless transmission module 30 is also disposed on the circuit board 25.

Then, a middle region 241 of the conductive element 24 is connected with a negative trace (not shown) of the circuit board 25. A first end 242 of the conductive element 24 is contacted with the first pen tube 20. A second end 243 of the conductive element 24 is located near a front end 211 of the second pen tube 21.

Then, the fixing post 23 is disposed under the circuit board 25 and located near the front end 211 of the second pen tube 21. Moreover, the fixing post 23 is contacted with the pressure sensor 28. Moreover, a helical part 292 of the conductive spring 29 is sheathed around the fixing post 23, and the conductive pen tip 22 is sheathed around the fixing post 23 and exposed outside the front end 211 of the second pen tube 21.

Moreover, the positive electrode part 27 is disposed on a top end of the circuit board 25 and connected with a positive trace (not shown) of the circuit board 25. The negative electrode part 26 is connected with the first pen tube 20.

After the above assembling process is completed, the user may grasp the first pen tube 20 and press the capacitive touch screen (not shown) with the conductive pen tip 22. Consequently, the electric energy of the human body is transmitted to the conductive pen tip 22 through the first pen tube 20, the conductive element 24, the circuit board 25, the conductive spring 29 and the fixing post 23. Alternatively, due to a coupling effect between the human body and the conductive element 24, the electric energy of the human body is transmitted to the conductive rubber tip 22 through the conductive element 24, the circuit board 25, the conductive spring 29 and the fixing post 23. Consequently, a pointing effect (not shown) on the capacitive touch screen is correspondingly generated.

Moreover, the coverage range of the conductive element 24 is extended from the rear end 212 of the second pen tube 21 to the front end 211 of the second pen tube 21. Consequently, when any position of the first pen tube 20 is grasped by the user, the electric energy of the human body may be transmitted to the conductive pen tip 22 through the conductive element 24, the circuit board 25, the conductive spring 29 and the fixing post 23. Consequently, a pointing effect (not shown) on the capacitive touch screen is correspondingly generated.

Moreover, by means of the circuit board 25, the passive touch pen 2 of this embodiment may provide the function of sensing the pen pressure. The function of sensing the pen pressure will be illustrated as follows. Firstly, a battery (not shown) is accommodated within a space between the negative electrode part 26 and the positive electrode part 27. Consequently, a conductive loop is defined by the negative trace of the circuit board 25, the conductive element 24, the first pen tube 20, the negative electrode part 26, the battery, the positive electrode part 27 and the positive trace of the circuit board 25 collaboratively. Under this circumstance, the circuit board 25 is powered by the battery, and thus the circuit board 25 is normally operated.

After the circuit board 25 is normally operated, the user may press the capacitive touch screen with the conductive pen tip 22. Consequently, the fixing post 23 is pushed by the conductive pen tip 22 and moved toward the pressure sensor 28. Then, the compressed force exerted on the pressure sensor 28 is transmitted from the controller to the wireless transmission module 30. According to the compressed force exerted on the pressure sensor 28, a corresponding signal is transmitted from the wireless transmission module 30 to the capacitive touch screen. According to the signal, a thicker line or a thinner line corresponding to the applied force of the user will be shown on the capacitive touch screen. Consequently, the function of sensing the pen pressure is achieved.

Moreover, in case that the applied force of the user is decreased, the acting force between the conductive spring 29 and the fixing post 23 will return the fixing post 23 to the original position. Under this circumstance, the compressed force exerted on the pressure sensor 28 is decreased.

Moreover, the passive touch pen 2 of this embodiment further comprises a plastic element 213 and a push switch 31 corresponding to the plastic element 213. The plastic element 213 is movable relative to the second pen tube 21. The cooperation of the plastic element 213 and the push switch 31 may provide the functions other than the pen pressure sensing function.

In this embodiment, the pressure sensor 28 is a piezoelectric pressure sensor. When the force pressing the pressure sensor 28 is increased, the resistance value of the pressure sensor 28 is decreased. It is noted that the pressure sensor 28 used in some other embodiments is not restricted to the piezoelectric pressure sensor. Another example of the pressure sensor 28 includes but is not limited to a capacitive pressure sensor or an optical pressure sensor. Moreover, an example of the wireless transmission module 30 includes but is not limited to a Bluetooth transmission module.

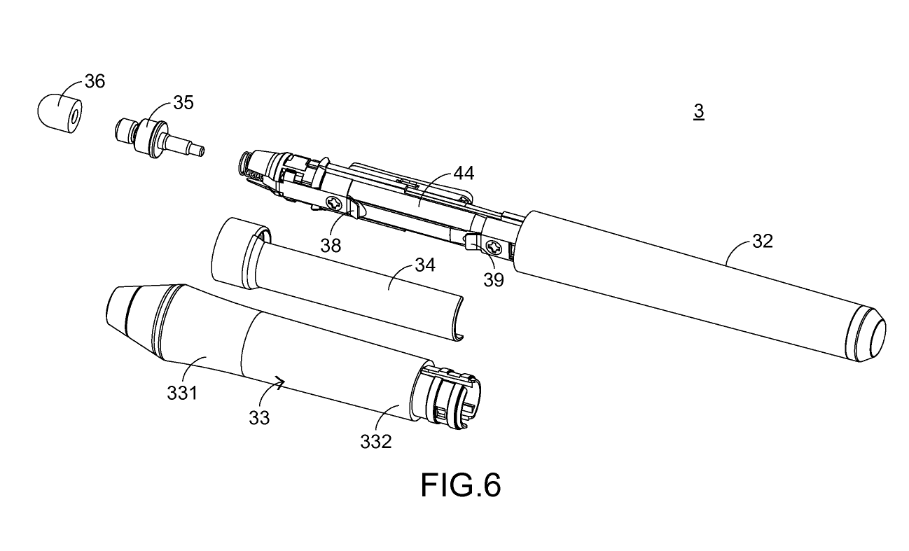

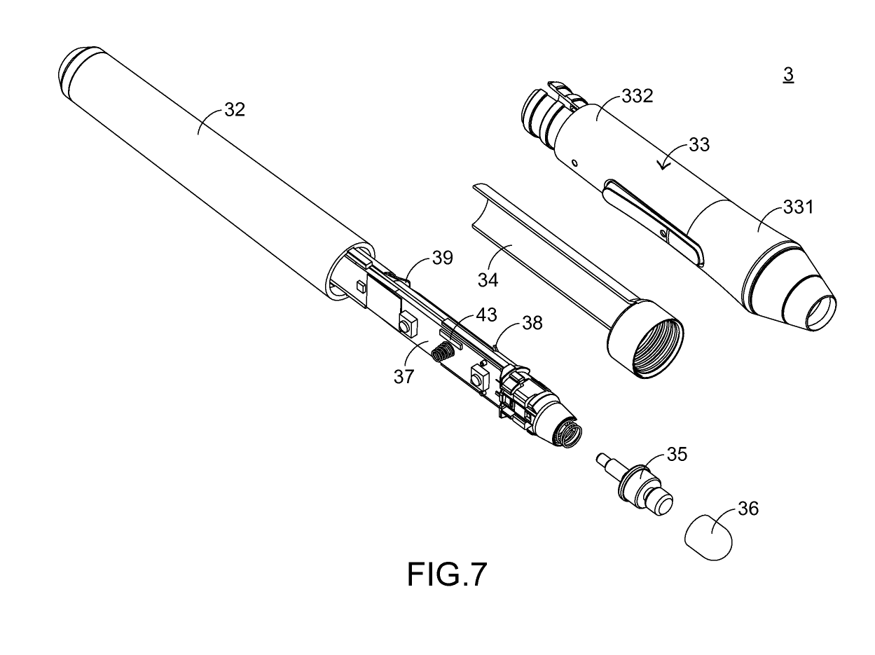

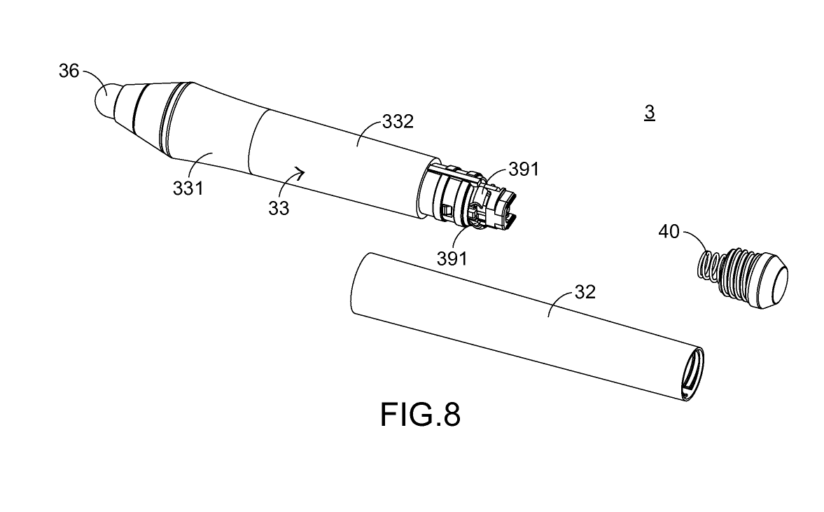

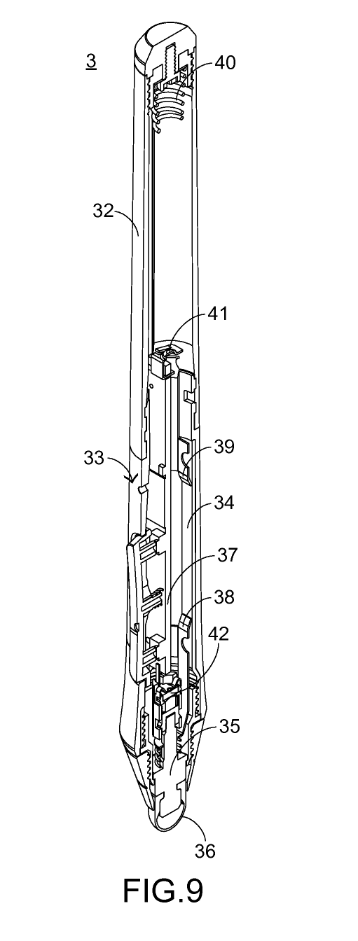

Hereinafter, a passive touch pen 3 according to a second embodiment of the present invention will be illustrated with reference to FIGS. 6-9. FIG. 6 is a schematic exploded view illustrating the inner structure of a second pen tube of a passive touch pen according to a second embodiment of the present invention and taken along a first viewpoint. FIG. 7 is a schematic exploded view illustrating the inner structure of the second pen tube of the passive touch pen according to the second embodiment of the present invention and taken along a second viewpoint. FIG. 8 is a schematic exploded view illustrating the inner structure of the first pen tube of the passive touch pen according to the second embodiment of the present invention. FIG. 9 is a schematic cutaway view illustrating the passive touch pen according to the second embodiment of the present invention.

As shown in FIGS. 6-9, the passive touch pen 3 comprises a first pen tube 32, a second pen tube 33, an inner metal plate 34, a fixing post 35, a conductive pen tip 36, a circuit board 37, a front conductive piece 38, a rear conductive piece 39, a negative electrode part 40, a positive electrode part 41, a pressure sensor 42, a wireless transmission module 43, and a fixing plate 44. For clarification and brevity, the fixing plate 44 is not shown in FIG. 9. The fixing plate 44 is connected with the circuit board 37 through a conductive spring, which is identical to the conductive spring of the first embodiment.

The rear conductive piece 39, the inner metal plate 34 and the front conductive piece 38 of the passive touch pen 3 of this embodiment are used to replace the conductive element 24 of the first embodiment. A process of assembling the passive touch pen 3 of this embodiment will be illustrated as follows.

Firstly, the circuit board 37 is connected with the fixing plate 44 and disposed within the second pen tube 33. The front conductive piece 38 is connected with the fixing plate 44 and located near a front end 331 of the second pen tube 33. The rear conductive piece 39 is connected with the fixing plate 44 and located near a rear end 332 of the second pen tube 33. In addition, the rear conductive piece 39 is connected with a negative trace (not shown) of the circuit board 37.

Moreover, the inner metal plate 34 is connected with an inner surface of the second pen tube 33, and integrally formed with the second pen tube 33. When the second pen tube 33 is connected with the first pen tube 32, the inner metal plate 34 is contacted with the front conductive piece 38 and the rear conductive piece 39. Consequently, the first pen tube 32, the rear conductive piece 39, the inner metal plate 34, the front conductive piece 38, the fixing post 35 and the conductive pen tip 36 are electrically connected with each other, and the electric energy of the human body can be transmitted through these components.

Please refer to FIGS. 8 and 9 again. A distal end 391 of the rear conductive piece 39 is protruded outside the rear end 332 of the second pen tube 33. When the second pen tube 33 is connected with the first pen tube 32, the distal end 391 of the rear conductive piece 39 is contacted with the first pen tube 32. After a battery (not shown) is accommodated within a space between the negative electrode part 40 and the positive electrode part 41, a conductive loop is defined by the negative trace of the circuit board 37, the rear conductive piece 39, the first pen tube 32, the negative electrode part 40, the battery, the positive electrode part 41 and the positive trace of the circuit board 37 collaboratively. Under this circumstance, the circuit board 37 is powered by the battery.

The remaining configuration, the assembling process and the operating principle of the passive touch pen 3 of this embodiment are identical to those of the passive touch pen 2 of the first embodiment, and are not redundantly described herein.

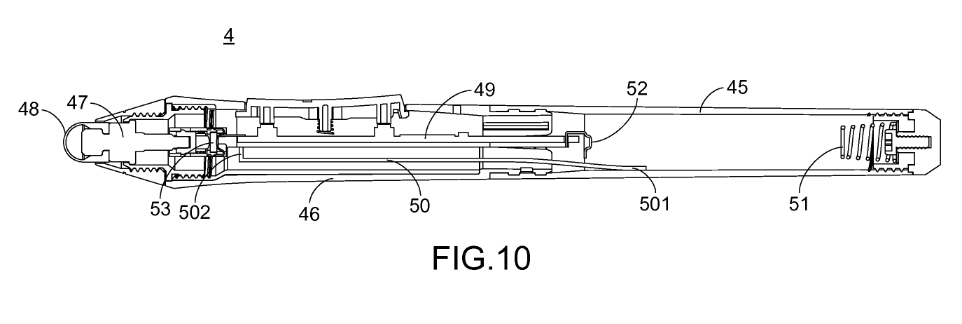

Hereinafter, a passive touch pen 4 according to a third embodiment of the present invention will be illustrated with reference to FIG. 10. FIG. 10 is a schematic perspective view illustrating the outer appearance of a passive touch pen according to a third embodiment of the present invention.

As shown in FIG. 10, the passive touch pen 4 comprises a first pen tube 45, a second pen tube 46, a fixing post 47, a conductive pen tip 48, a circuit board 49, a conductive element 50, a negative electrode part 51, a positive electrode part 52, and a pressure sensor 53. The fixing plate 47 is connected with the circuit board 49 through a conductive spring, which is identical to the conductive spring of the first embodiment.

In comparison with the first embodiment, the conductive element 50 is a conductive wire or a flexible printed circuit board. Moreover, a first end 501 of the conductive element 50 is connected with the first pen tube 45, and a second end 502 of the conductive element 50 is connected with a negative trace of the circuit board 49.

The remaining configuration, the assembling process and the operating principle of the passive touch pen 4 of this embodiment are identical to those of the passive touch pen 2 of the first embodiment, and are not redundantly described herein.

From the above descriptions, the electric energy of the human body is transmitted to the conductive pen tip through the conductive element (e.g. the elongated conductive plate, the conductive wire or a flexible printed circuit board) or through the inner metal plate, the front conductive piece and the rear conductive piece. Consequently, the second pen tube may be made of the nonconductive material. Under this circumstance, the fabricating cost of the passive touch pen is reduced. Consequently, the complexity of the fabricating process and the fabricating cost are reduced

Moreover, since the conductive element (e.g. the elongated conductive plate, the conductive wire or a flexible printed circuit board) or the rear conductive piece is contacted with the negative trace of the circuit board and the first pen tube simultaneously, the negative electrode part is electrically connected with the negative trace through the first pen tube. That is, it is not necessary to install any other connecting element. Under this circumstance, the complexity of the fabricating process and the fabricating cost are both reduced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A passive touch pen for a capacitive touch screen, the passive touch pen comprising:
a first pen tube made of a conductive material;
a second pen tube made of a nonconductive material, wherein a rear end of the second pen tube is connected with the first pen tube;
a fixing post made of a conductive material, wherein the fixing post is disposed within the second pen tube and located near a front end of the second pen tube;
a conductive pen tip connected with the fixing post and exposed outside the front end of the second pen tube;
a circuit board disposed within the second pen tube; and
a conductive element disposed within the second pen tube and connected with a negative trace of the circuit board, wherein a first end of the conductive element is contacted with the first pen tube, so that the first pen tube, the conductive element, the fixing post and the conductive pen tip are electrically connected with each other.

2. The passive touch pen according to claim 1, wherein the conductive element is an elongated conductive plate, and a second end of the conductive element is located near the fixing post.

3. The passive touch pen according to claim 1, wherein the conductive element is a conductive wire or a flexible printed circuit board, and a second end of the conductive element is connected with the negative trace of the circuit board.

4. The passive touch pen according to claim 1, wherein the passive touch pen further comprises:
a negative electrode part connected with the first pen tube; and
a positive electrode part connected with a positive trace of the circuit board,
wherein when a battery is accommodated within a space between the negative electrode part and the positive electrode part, a conductive loop is defined by the negative trace, the conductive element, the first pen tube, the negative electrode part, the battery, the positive electrode part and the positive trace collaboratively, so that the circuit board is powered by the battery.

5. The passive touch pen according to claim 1, wherein the passive touch pen further comprises:
a pressure sensor connected with the circuit board and located beside the fixing post, wherein when the pressure sensor is pressed by the fixing post, a compressed force exerted on the conductive pen tip is sensed by the pressure sensor;
a conductive spring connected with the circuit board and sheathed around the fixing post, wherein the fixing post is returned to an original position by the conductive spring; and
a wireless transmission module disposed on the circuit board, wherein according to the compressed force exerted on the conductive pen tip, the wireless transmission module issues a corresponding signal to the capacitive touch screen.

6. The passive touch pen according to claim 5, wherein the wireless transmission module is a Bluetooth transmission module.

7. A passive touch pen for a capacitive touch screen, the passive touch pen comprising:
a first pen tube made of a conductive material;
a second pen tube made of a nonconductive material, wherein a rear end of the second pen tube is connected with the first pen tube;
an inner metal plate connected with the second pen tube;
a fixing post made of a conductive material, wherein the fixing post is disposed within the second pen tube and located near a front end of the second pen tube;
a conductive pen tip connected with the fixing post and exposed outside the front end of the second pen tube;
a circuit board disposed within the second pen tube;
a front conductive piece disposed within the second pen tube, located near the conductive pen tip, and contacted with the inner metal plate; and
a rear conductive piece disposed within the second pen tube, located near the rear end of the second pen tube, and connected with a negative trace of the circuit board, wherein the rear conductive piece is connected with the first pen tube and the inner metal plate, so that the first pen tube, the rear conductive piece, the inner metal plate, the front conductive piece, the fixing post and the conductive pen tip are electrically connected with each other.

8. The passive touch pen according to claim 7, wherein the passive touch pen further comprises:
a negative electrode part connected with the first pen tube; and
a positive electrode part connected with a positive trace of the circuit board,
wherein when a battery is accommodated within a space between the negative electrode part and the positive electrode part, a conductive loop is defined by the negative trace, the rear conductive piece, the first pen tube, the negative electrode part, the battery, the positive electrode part and the positive trace collaboratively, so that the circuit board is powered by the battery.

9. The passive touch pen according to claim 7, wherein the passive touch pen further comprises:
a pressure sensor connected with the circuit board and located beside the fixing post, wherein when the pressure sensor is pressed by the fixing post, a compressed force exerted on the conductive pen tip is sensed by the pressure sensor;
a conductive spring connected with the circuit board and sheathed around the fixing post, wherein the fixing post is returned to an original position by the conductive spring; and
a wireless transmission module disposed on the circuit board, wherein according to the compressed force exerted on the conductive pen tip, the wireless transmission module issues a corresponding signal to the capacitive touch screen.
